(19) United States
(12) Patent Application Publication
(10) Pub. No.: US 2005/0060688 A1
(43) Pub. Date: Mar. 17, 2005

(54) Automated source code software programmer's manual generator

(76) Inventor: Chandra H. Kamalakantha, Plano, TX (US)

Correspondence Address: STEPHEN R. LOE, THE LAW OFFICE OF STEPHEN R. LOE, P.O. BOX 649, FRISCOE, TX, 75034, US

(21) Appl. No.: 10/854,118

(22) Filed: May 26, 2004

Related U.S. Application Data
(60) Provisional application No. 60/503,557, filed on Sep. 17, 2003.

(51) Int. Cl. G06F 9/44

(52) U.S. Cl. 717/123

(57) ABSTRACT

A method, system, and computer program product for generating a software documentation file from a software source code file is provided. In one embodiment, the source code file for the software is read by the automatic program documentation generation tool. The tool extracts software documentation from the source code file, by for example, locating documentation begin and end indicia within the source code and extracting the data contained within the indicia. The documentation has been previously written into the source code by a software developer, programmer, or engineer. The tool then creates a software documentation file, such as, for example, a UNIX Man Page or an HTML page, from the extracted software documentation extracted from the source code. The software documentation file is typically stored in a central repository.

### BACKGROUND OF THE INVENTION

1. Technical Field

The present invention relates generally to computer software and, more particularly, to automated generation of software code documentation.

2. Description of Related Art

Systems Engineers who support and maintain UNIX batch systems are always in a major dilemma when faced with problems while 1) Trouble shooting batch program issues or 2) Estimating and making changes to existing sub-systems. The reason for this is that either there is no program design, flow and documentation of the sub-systems of the systems in question or there is no up to date program design, flow and documentation of the sub-systems of the systems in question. The only way out of this dilemma is to read the code and decipher the logic. However, this could prove too costly when the correction window for correcting the problems, which is defined by the Service Level Agreement (SLA), is very short.

One reason for lack of documentation is mainly due to the fact that the developer has to maintain the information in more than one place and it gets out of date too quickly. Currently, there are no tools available to aid the developer in maintaining proper documentation. Therefore, it would be desirable to have a method, system, and computer program product, which functions, for example, in a UNIX environment, that takes a C/C++/Pro*C/Cobol/Pro*Cobol, shell script source file, or other programming source file as input and automatically generates a technical document of program flow, design document, and other relevant documentation information.

### SUMMARY OF THE INVENTION

The present invention provides a method, system, and computer program product for generating a software documentation file from a software source code file. In one embodiment, the source code file for the software is read by the automatic program documentation generation tool. The tool extracts software documentation from the source code file, by for example, locating documentation begin and end indicia within the source code and extracting the data contained within the indicia. The documentation has been previously written into the source code by a software developer, programmer, or engineer. The tool then creates a software documentation file, such as, for example, a UNIX Man Page or an HTML page, from the extracted software documentation extracted from the source code. The software documentation file is typically stored in a central repository.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server in accordance with the present invention;

FIG. 3 depicts a block diagram of a data processing system in which the present invention may be implemented;

FIG. 4 depicts a diagram illustrating an exemplary program function and process flow for creating program documentation from software code in accordance with one embodiment of the present invention;

FIG. 5 depicts an exemplary HTML page generated with a program documentation generation tool in accordance with one embodiment of the present invention;

FIG. 6 depicts an exemplary UNIX Man Page produced with a program documentation generation tool in accordance with one embodiment of the present invention;

FIG. 7 depicts an exemplary subcomponent of a source code in accordance with one embodiment of the present invention; and

FIG. 8 depicts a resulting UNIX man page 800 generated from subcomponent 700 in accordance with one embodiment of the present invention.

### DETAILED DESCRIPTION OF THE PREFERRED EMBODIMENT

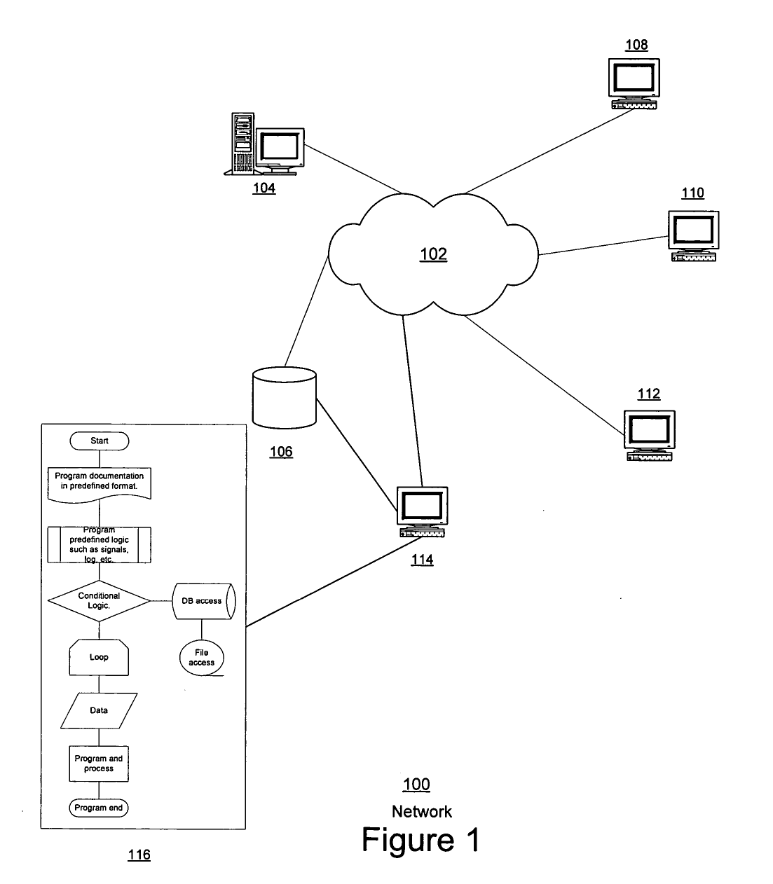

With reference now to the figures, and in particular with reference to FIG. 1, a pictorial representation of a distributed data processing system is depicted in which the present invention may be implemented.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to network 102, along with storage unit 106. Clients 108, 110 and 112 are also connected to network 102. These clients, 108, 110 and 112, may be, for example, personal computers or network computers. In addition, client 114 is connected to storage unit 106. For purposes of this application, a network computer is any computer coupled to a network that receives a program or other application from another computer coupled to the network. In the depicted example, server 104 provides access to software program documentation manuals residing on storage unit 106 to clients 108-112. Clients 108, 110 and 112 are clients to server 104. Distributed data processing system 100 may include additional servers, clients, and other devices not shown.

Software code 116 is coded on, for example, client 114 and then compiled and stored such that the executable file for software code 116 resides on storage unit 106. During the process of compiling the code 116, a program documentation generation tool, residing on client 114, or alternatively, on another data processing system in distributed data processing system 100, parses the code and creates a documentation file based on comments and other entries within the software code 116. This documentation file is then stored on storage unit 106 and is available to other users, such as, for example, programmers and engineers, who may later be required to modify the software and correct bugs or errors in the software. The program documentation generation tool may produce one or more file types, such as, for example, a Hypertext Markup Language (HTML) file and a standard UNIX manual (man) page format. Of course, other formats may be utilized as well. Thus, for example, users of clients 108-112 may receive the documentation in an HTML format which is easily transmitted over a network using existing internet protocols and standard web browsers, thereby not requiring any specialized software to be loaded onto clients 108-112 in order to view the program documentation generated by the program documentation generation tool and stored on storage unit 106. Alternatively, a user may view the documentation in a different format, such as, for example, the UNIX man page format, and access the program documentation file directly from storage unit 106 such as with client 114. Therefore, in one embodiment, the tool empowers the developer to generate the documentation in at least two main stream methods and is configurable 1) in a UNIX man page, which is useful when the Information Technology (IT) organization is mainly UNIX and 2) in an HTML based document which can be shared across multiple platforms.

Thus, the program documentation generation tool of the present invention empowers the developer to maintain the program specifications, program flow and technical design details in one place (i.e. in the code module itself) and automatically generate the program specification, design and program flow from the code with zero effort during compilation (i.e., before the module is deployed from Development→Test→Production migration). This ensures that the program documentation matches the current version of the software code, thereby preventing other engineers and programmers from wasting valuable time trying to match an out of date program manual or documentation with a different version of the software code. Thus, improvements and modifications to the code are facilitated with the program documentation generation tool of the present invention. Furthermore, the software developer is required to enter program documentation, flow charts, and other relevant information in a single place rather than in multiple locations. This increases the speed with which the developer can perform his tasks as well as ensures that there are no errors and/or discrepancies between documentation within the code and other repositories of the software code documentation.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks such as, for example, an intranet or a local area network.

FIG. 1 is intended as an example and not as an architectural limitation for the processes of the present invention.

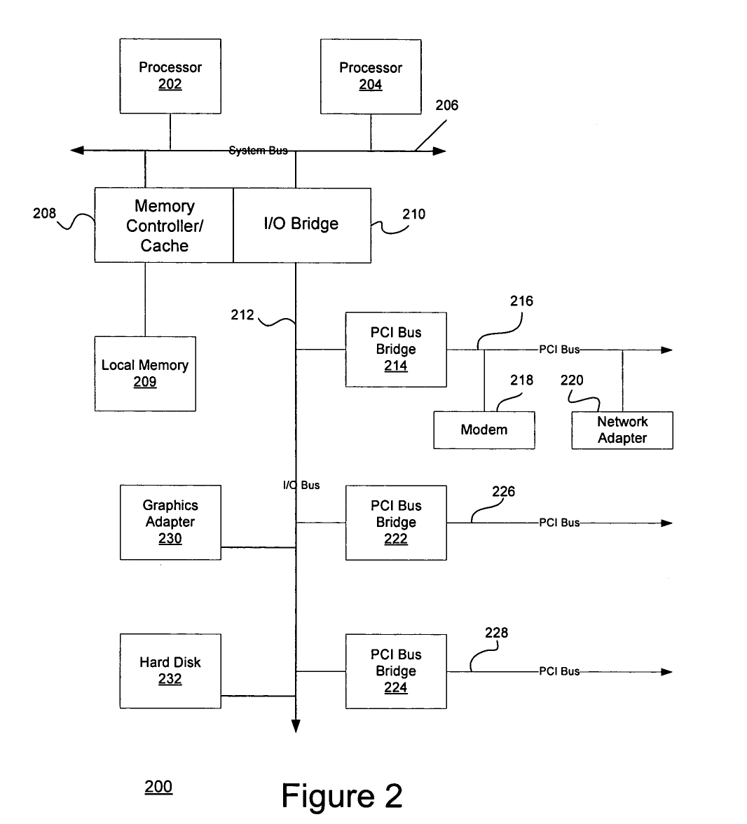

Referring to FIG. 2, a block diagram of a data processing system which may be implemented as a server, such as server 104 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

Data processing system 200 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries

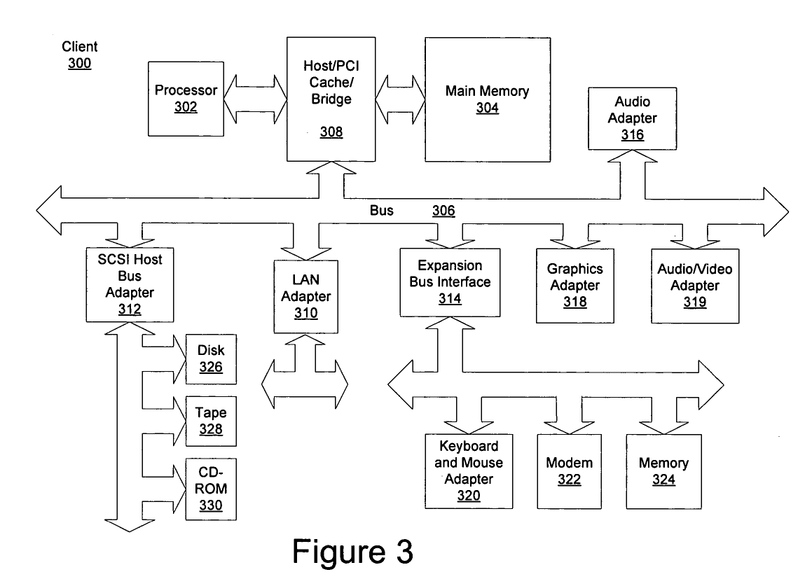

With reference now to FIG. 3, a block diagram of a data processing system in which the present invention may be implemented is illustrated. Data processing system 300 is an example of a client computer, such as, for example, any one of clients 108, 110, 112, and 114 depicted in FIG. 1. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

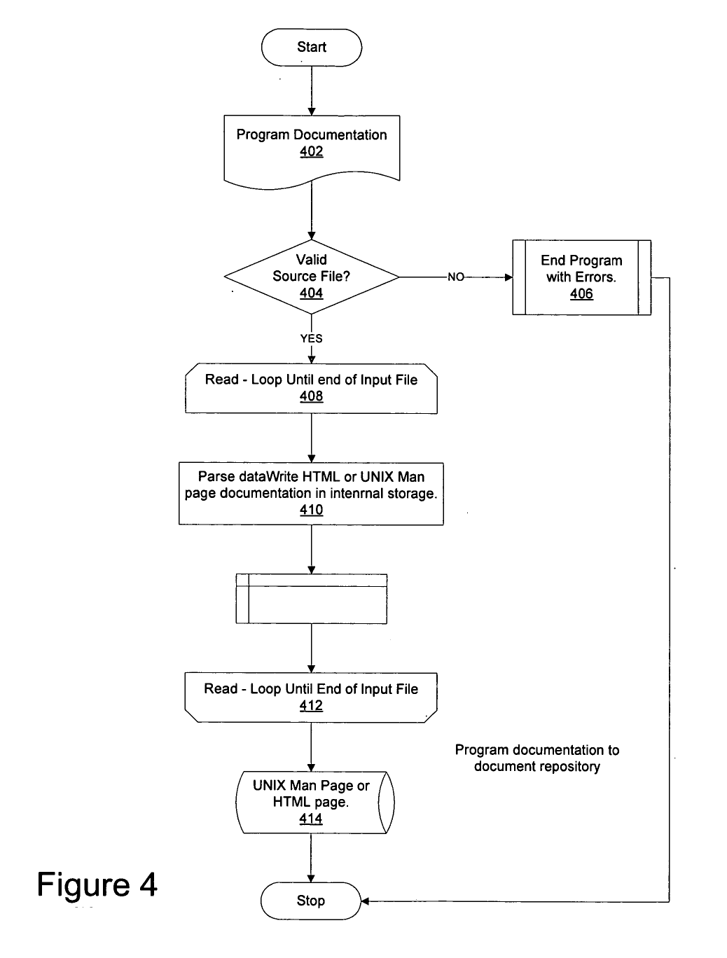

With reference now to FIG. 4, a diagram illustrating an exemplary program function and process flow for creating program documentation from software code is depicted in accordance with one embodiment of the present invention. To begin, the program documentation generation tool is invoked, for example, by the compilation of a source code, and receives program source code file (step 402). The program documentation generation tool determines whether the file is a valid source code file (step 404). If the source file is not a valid source code, then the program documentation generation tool is ended with errors (step 406).

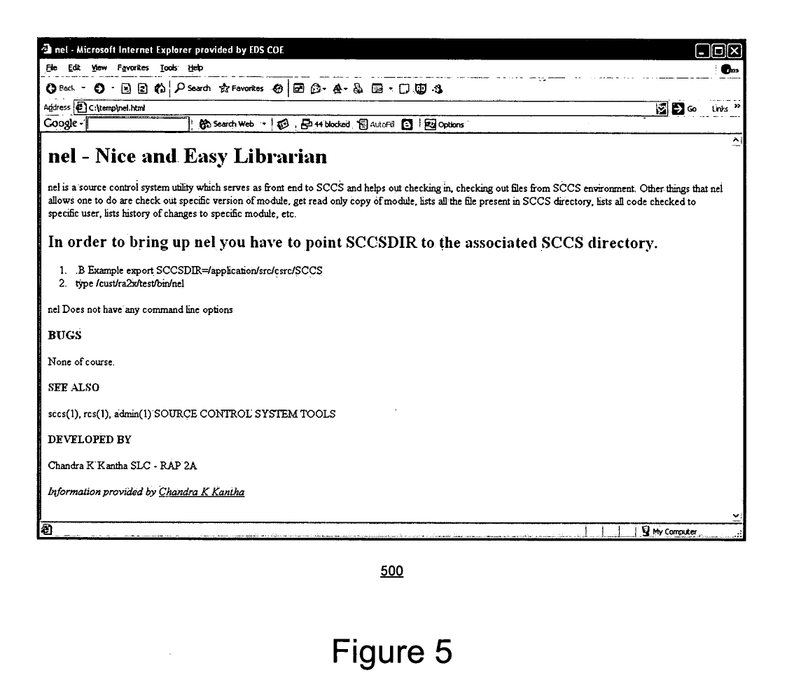

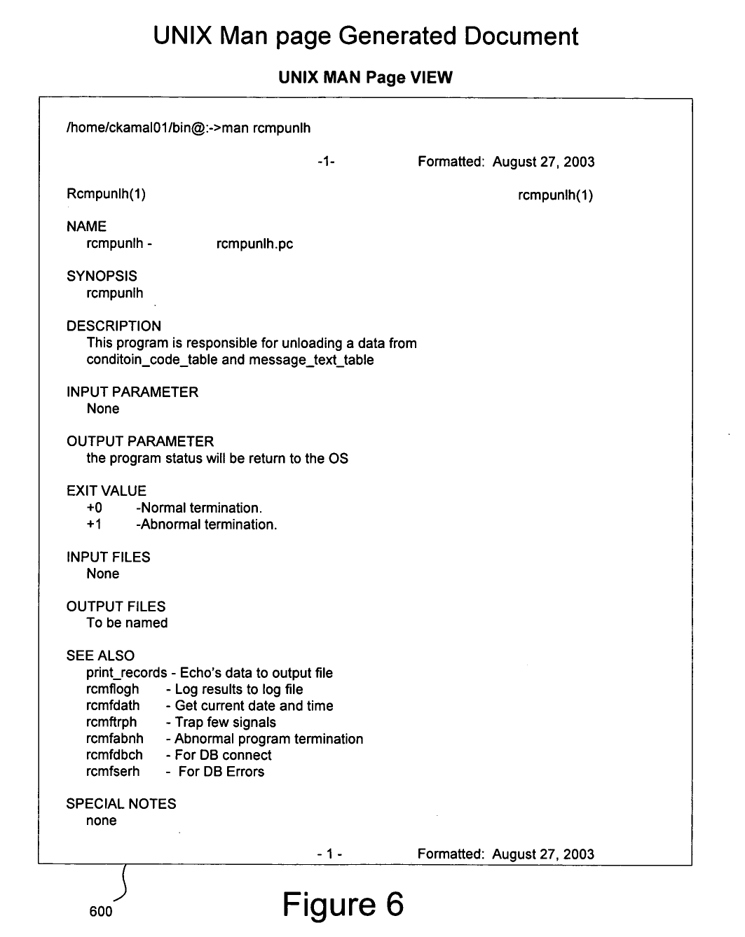

However, if the file is a valid source file, then the program documentation tool begins a read loop until the end of Input File is reached (step 408). During the read loop, the tool parses the data in the program source code and writes an HTML, UNIX Man page, and/or other file type into internal storage (step 410). The program source code is expected to be in a predefined format conforming to a specified or existing programming standard. Once the tool has reached the end of input file and completed the read loop (step 412), a UNIX Man Page, HTML page, and/or other file type page is stored in internal storage in the document repository (step 414) and may be reviewed by other programmers and/or engineers. Screen 500 depicted in FIG. 5 illustrates an exemplary HTML page generated with a program documentation generation tool of the present invention. Page 600 depicted in FIG. 6 illustrates an exemplary UNIX Man Page produced with a program documentation generation tool of the present invention. Thus, as long as the software developer adheres to standard programming protocols, the developer merely has to create program documentation once in the source code and the programming documentation generation tool creates all other documentation. Therefore, as long as the developer keeps the program documentation up to date in the program source code, all the rest of the manuals are kept up to date automatically by the tool of the present invention.

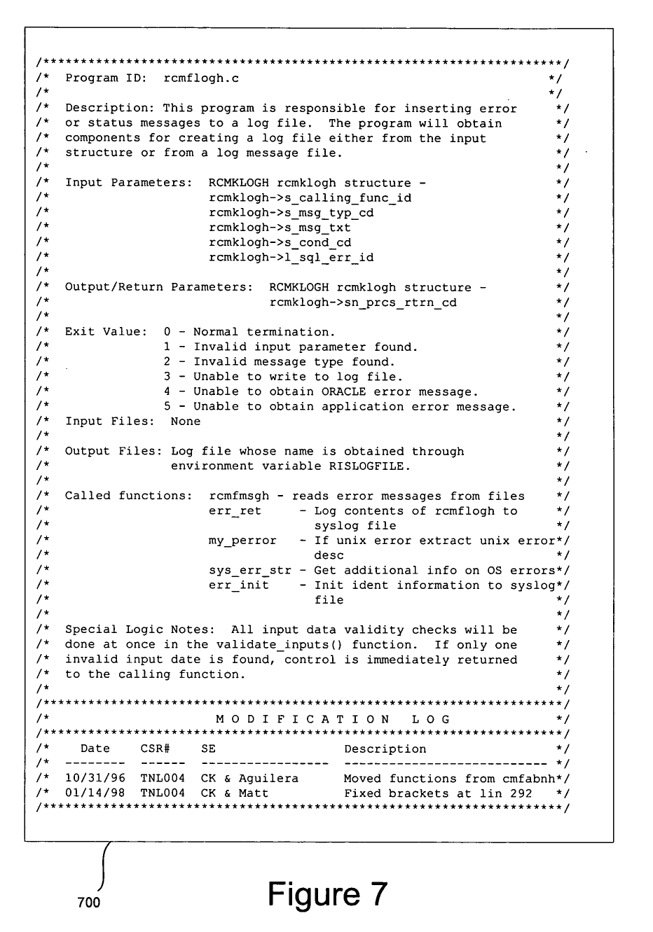

Turning now to FIG. 7, an exemplary subcomponent of a source code is depicted in accordance with one embodiment of the present invention. In this example, the source code contains subcomponent 700 which contains program documentation for the source code. The program documentation generation tool is invoked during build time and reads the program/product at run time stripping out documentation blocks that are in pre-defined format and only parses out document lines to be inserted to the final product/program document it creates. Documentation blocks begin-blocks and end-blocks can be thought of, for example, as special key words such as Extensible Markup Language (XML) key words.

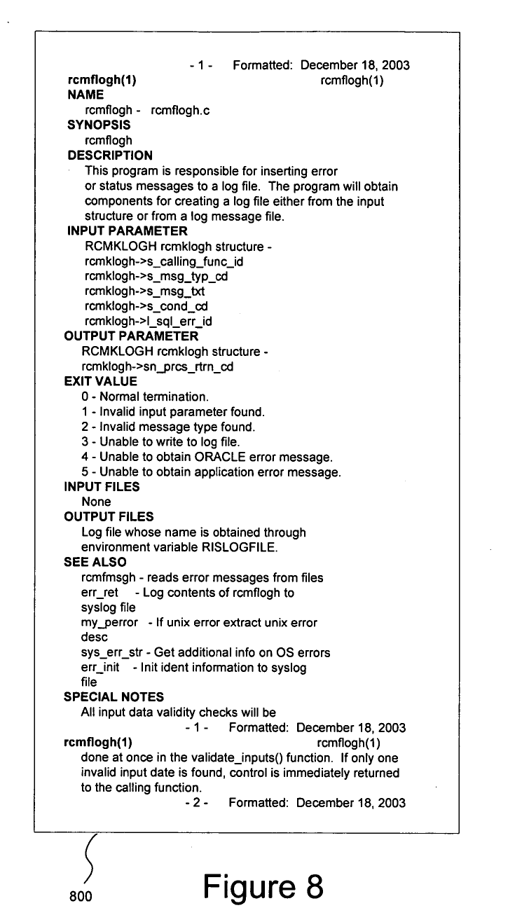

In the program subcomponent 700 shown in FIG. 7, everything that is within the block beginning with /**************/ and ending with /************/ is interpreted as the documentation of the program. Within the documentation block key words such as “Program ID:”, “Description:”, “Input Parameters:”, “Output/Return parameters:”, “Exit Value:”, “Input Files:”, “Output Files:”, “Called Functions:”, “Special Notes:”, and “MODIFCATION LOG” are interpreted as key words on the documents to bold and italics using man page generator or HTML key words to generate a good documentation out of the program/product. The resulting UNIX man page 800 generated from subcomponent 700 is depicted in FIG. 8.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for generating software documentation file from a software source code file, the method comprising:
reading a source code file;
extracting software documentation from the source code file; and
creating a software documentation file from the extracted software documentation.

2. The method as recited in claim 1, wherein the step of extracting software documentation comprises locating begin documentation indicia and end documentation indicia within the source code file and extracting the data from within the begin and end documentation indicia.

3. The method as recited in claim 1, wherein the extracted software documentation is parsed to determine key words and the key words special formatting is applied to the key words in the creation of the software documentation file.

4. The method as recited in claim 1, wherein the software documentation file is a UNIX manual page.

5. The method as recited in claim 1, wherein the software documentation file is a Hypertext Markup Language file.

6. The method as recited in claim 1, further comprising:
storing the software documentation file in a central repository.

7. A computer program product in a computer readable media for use in a data processing system for generating software documentation file from a software source code file, the computer program product comprising:
first instructions for reading a source code file;
second instructions for extracting software documentation from the source code file; and
third instructions for creating a software documentation file from the extracted software documentation.

8. The computer program product as recited in claim 7, wherein the second instructions for extracting software documentation comprise locating begin documentation indicia and end documentation indicia within the source code file and extracting the data from within the begin and end documentation indicia.

9. The computer program product as recited in claim 7, wherein the extracted software documentation is parsed to determine key words and the key words special formatting is applied to the key words in the creation of the software documentation file.

10. The computer program product as recited in claim 7, wherein the software documentation file is a UNIX manual page.

11. The computer program product as recited in claim 7, wherein the software documentation file is a Hypertext Markup Language file.

12. The computer program product as recited in claim 7, further comprising:
fourth instructions for storing the software documentation file in a central repository.

13. A system for generating software documentation file from a software source code file, the system comprising:
first means for reading a source code file;
second means for extracting software documentation from the source code file; and
third means for creating a software documentation file from the extracted software documentation.

14. The system as recited in claim 13, wherein the second means for extracting software documentation comprise locating begin documentation indicia and end documentation indicia within the source code file and extracting the data from within the begin and end documentation indicia.

15. The system as recited in claim 13, wherein the extracted software documentation is parsed to determine key words and the key words special formatting is applied to the key words in the creation of the software documentation file.

16. The system as recited in claim 13, wherein the software documentation file is a UNIX manual page.

17. The system as recited in claim 13, wherein the software documentation file is a Hypertext Markup Language file.

18. The system as recited in claim 13, further comprising:
fourth means for storing the software documentation file in a central repository.
